(19) United States
(12) Patent Application Publication
(10) Pub. No.: US 2019/0244437 A1
(43) Pub. Date: Aug. 8, 2019

(54) STOP and Wait; Drivers Meter Rating

(71) Applicant: Godwin E. Enogieru, Dallas, TX (US)

(72) Inventor: Godwin E. Enogieru, Dallas, TX (US)

(21) Appl. No.: 15/891,545

(22) Filed: Feb. 8, 2018

(51) Int. Cl. G07B 13/04; G06Q 30/02

(52) U.S. Cl. CPC G07B 13/04; G06F 3/048; G06Q 2240/00; G06Q 30/0282

(57) ABSTRACT

This disclosure relates to KROOZ apps which enables KROOZ driver to have the ability to click on a “Stop & Wait” button built on our driver apps. If a rider asked the driver to stop during the ride for any reason, example to stop and buy something on the way or so, and while the driver wait for the customer during the ride the rider will be charged for the driver WAIT time presently preset at $0.55 cents per minute. In-addition KROOZ unique creative design to enable our customer rate and review the KROOZ driver respectively.

### BACKGROUND

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to an app which enables KROOZ driver to click on a “Stop & Wait” button built on our driver apps and to rate and review the KROOZ driver respectively.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 100 shows stop and wait timer.

FIG. 200 shows the rating view of the app.

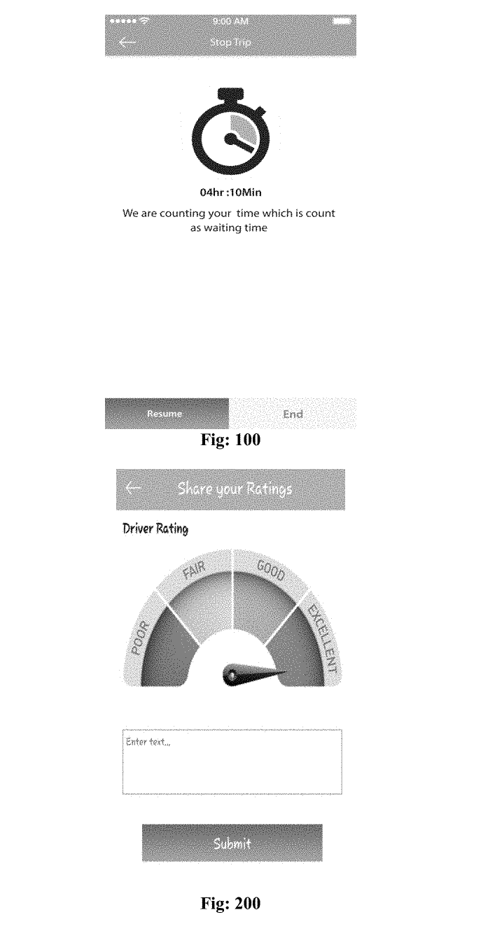

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Before explaining the invention in detail, it is to be understood that the invention is not limited in its application to the detail of application illustrated in the drawings since the invention is capable of other embodiments and of being practiced or carried out in various ways. It is also to be understood that the phraseology or terminology employed is for the purpose of description only and not of limitation.

STOP & WAIT:

This feature enable KROOZ driver have the ability to click on a “Stop & Wait” button built on our driver apps. If a rider asked the driver to stop during the ride for any reason, example to stop and buy something on the way or so, and while the driver wait for the customer during the ride the rider will be charged for the driver WAIT time presently preset at $0.55 cents per minute. This unique feature is located on KROOZ driver apps.

How the Stop & Wait Features Works:

When a customer asked our driver to stop during the trip, KROOZ driver will activate the STOP & WAIT button located on KROOZ Driver app. When the Stop & Wait button is activated, a digital clock displayed on the KROOZ driver's app screen will start counting minutes until the STOP & Wait is deactivated. When the STOP & WAIT is deactivated a sub-total amount of the wait time based on the preset Stop & Wait amount on the KROOZ platform is added to the total amount of the customer ride fare.

The Stop & Wait enable KROOZ Drivers earn extra money while they wait for customer at anytime during the ride, and also gives our customer the flexibility of enjoying the KROOZ ride share service.

Meter Style Driver Rating:

This is KROOZ unique creative design to enable our customer rate and review t KROOZ driver respectively. The meter style feature is located on KROOZ customer apps.

How the Meter Style Driver Rating Feature Works:

KROOZ created a stylish meter style driver rating system, which can easily been moved with finger tip from red color to green based on the rating the individual customer deemed or desired to give the driver with the text entitled poor, fair, good, excellent position.

The KROOZ interactive meter style rating system comprises of a moveable black arrow pointing to color green, light green, yellow, and red. Underneath which consist a text box that enable customer write a review before clicking on submit.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A meter style driver rating comprising:
1) to click on a “Stop & Wait” button built on our driver apps, and while the driver wait for the customer during the ride the rider will be charged for the driver WAIT time presently preset at $0.55 cents per minute.
2) Unique creative design to enable our customer rate and review the KROOZ driver.
